(19) United States
(12) Patent Application Publication
(10) Pub. No.: US 2014/0172396 A1
(43) Pub. Date: Jun. 19, 2014

(54) AUTOMATED MODEL-BASED METHOD FOR GENERATING PHYSICAL SYSTEMS ARCHITECTURES AND OPTIMIZING SAME

(71) Applicant: Nicolas Albarello, Toulouse (FR)

(72) Inventor: Nicolas Albarello, Toulouse (FR)

(73) Assignee: EUROPEAN AERONAUTIC DEFENCE AND SPACE COMPANY EADS FRANCE, Paris (FR)

(21) Appl. No.: 14/233,877

(22) PCT Filed: Jul. 16, 2012
(86) PCT No.: PCT/EP2012/063876

§ 371 Date: Jan. 24, 2014

(30) Foreign Application Priority Data
Jul. 20, 2011 (FR) 1156561

(51) Int. Cl. G06F 17/50

(52) U.S. Cl. CPC G06F 17/5009
USPC 703/6

(57) ABSTRACT

A method for generating and optimizing physical system architecture by modeling a problem in the form of a model. The physical architectures (AP₁, AP₂, . . . , AP_{N}) are generated using the model and algorithm that searches for a function with viable and valid combination of components. The physical architectures are evaluated according to a plurality of attributes or criteria using analysis modules based on the model. A part of the physical architectures is selected based on dominance relations. New physical architectures (AP′₁, AP′₂, . . . , . . . , AP′_{N}) are generated by applying genetic operators to the physical architectures (AP₁, AP₂, . . . , AP_{N}). The results are synthesized by retaining a part of the physical architectures.

### FIELD OF THE INVENTION

The present invention relates to the field of physical systems architectures. The present invention relates more particularly to an automated model-based method for generating physical systems architectures and optimizing them.

The present invention makes it possible to automatically create physical systems architectures from a functional system architecture, based on a set of usable physical components (component catalog). Several design alternatives are thus generated. The method according to the present invention then makes it possible to modify these alternatives based on an evaluation of their performance in order to determine the best performing architectures.

### PRIOR ART

Complex system design involves a large design space, which can be defined as all of the possible combinations of components and their various allocations, and which is generally composed of several thousand alternatives. These alternatives consist in different arrangements of components performing the functions allocated to the system in question. It is impossible to evaluate all these alternatives without the use of an automated design space exploration process. The present invention makes it possible to automate these analyses in order to thoroughly explore the design space and find the best performing architectures. This makes it possible to obtain, with near certainty, architectures in an optimal global area of the design space, and thus, to guarantee optimal quality for the adopted solution.

Currently, for highly complex systems, two approaches may be identified:
the architecture is adapted to that of a similar system (previous program, for example)
an in-depth study is conducted, relying on the judgment of the engineer. A design space is identified and categories of architectures are iteratively eliminated based on experience, expertise, or beliefs.

Recently, scientific approaches for generating physical architectures have been proposed. For the most part, they are based on the definition of explicit rules, whether purely physical [the scientific publications K. Seo, Z. Fan, J. Hu, and E. Goodman, “Toward an automated design method for multi-domain dynamic systems using bond graph and genetic programming,” Mechatronics, 2003, pp. 1-21, and R. Rai, “Simulation-Based Design of Aircraft Electrical Power Systems,” modelica.org, 2011] (a set of components can be replaced by or associated with another set of components) or functional/physical [the scientific publications T. Kurtoglu and M.I. Campbell, “Automated synthesis of electromechanical design configurations from empirical analysis of function to form mapping,” Journal of Engineering Design, Vol. 20, 2009, p. 83-104, and V. Holey, “Toward the prediction of multiphysic interactions using MDM and QFD matrices,” Design, 2010, pp. 1-11] (a function can be performed by a set of components). These approaches require the definition of a large number of rules. The approach according to the present invention is distinguished by the fact that there are only two rules to define.

In the published patent applications of the prior art, there is currently no method for generating design alternatives for physical architectures. Only methods for manually describing or designing these architectures have been proposed.

The known prior art includes, for example, French patent application No. FR 2,846,117 (Renault), which describes a method and device for synthesizing an electrical architecture. This French patent application discloses a method for synthesizing an electrical and electronic architecture of at least a part of a product comprising electrical wires and electrical and electronic components such as sensors, actuators, and control units.

The known prior art also includes French patent application No. FR 2,905,491 (EADS Germany), which relates to the allocation of functions to a predetermined physical architecture. This French patent application describes an automated model-based method for integrating a functional system architecture with a physical system architecture to form an electronic system.

### DESCRIPTION OF THE INVENTION

The object of the present invention is to overcome the drawbacks of the prior art by proposing a method for generating design alternatives from a functional architecture and a set of physical components, then iteratively modifying these alternatives in order to explore the design space (all of the possible combinations of components and their various allocations).

To this end, the present invention, in its most general sense, relates to a method for generating and optimizing physical systems architectures, characterized in that it comprises the following steps:
modeling a problem in the form of a model;
generating physical architectures using said model and an algorithm that searches for a viable and valid combination of components for a function;
evaluating said physical architectures in terms of several attributes or criteria using analysis modules based on said model;
selecting a part of said physical architectures based on dominance relations;
generating new physical architectures by applying genetic operators to the previous physical architectures; and
synthesizing the results, retaining only a part of said physical architectures.

The present invention also makes it possible to optimize the quality of the physical architectures generated.

According to a variant, said selection of a part of said physical architectures is made based on Pareto dominance relations.

Advantageously, said selection of a part of said physical architectures is made using the NSGA-II (“Non-Dominated Sorting Genetic Algorithms”) method.

According to a variant, said selection of a part of said physical architectures is made based on dominance relations, in accordance with the preferences of the user(s) of the method.

Advantageously, said selection of a part of said physical architectures is made using the NEMO (“Necessary-preference-enhanced Evolutionary Multiobjective Optimizer”) method.

According to one embodiment, said genetic operators include a replication operator. Said replication operator replicates an alternative from the previous population in the subsequent population.

According to one embodiment, said genetic operators include a mutation operator. Said mutation operator modifies an alternative from the previous population (parent) by selecting a part of the architecture and replacing it with a component combination that is equivalent (i.e. viable and capable of performing the same functions). The new architecture thus created (child) is placed in the subsequent population.

According to one embodiment, said genetic operators include a crossover operator. Said crossover operator exchanges parts of two (parent) architectures from the previous population with each other to create two new alternatives (children), which are placed in the subsequent population.

Preferably, during the step for modeling a problem in the form of a model, a designer describes a system, its interfaces with an environment, a functional architecture, and physical components to be considered.

The present invention also relates to a computer program characterized in that it comprises program code instructions for executing the steps of the above-mentioned method when said program is executed in or by a processor.

The present invention also relates to a device for implementing the above-mentioned method.

### BRIEF DESCRIPTION OF THE DRAWINGS

The invention will be better understood with the help of the description, provided below for purely explanatory purposes, of an embodiment of the invention, in reference to the Figures, in which:

FIG. 1 illustrates the method for generating physical architectures according to the present invention;

FIG. 2 is an overall view of the method according to the present invention; and

FIGS. 3a through 3d represent an exemplary search for a possible combination for a given function.

### DETAILED DESCRIPTION OF EMBODIMENTS OF THE INVENTION

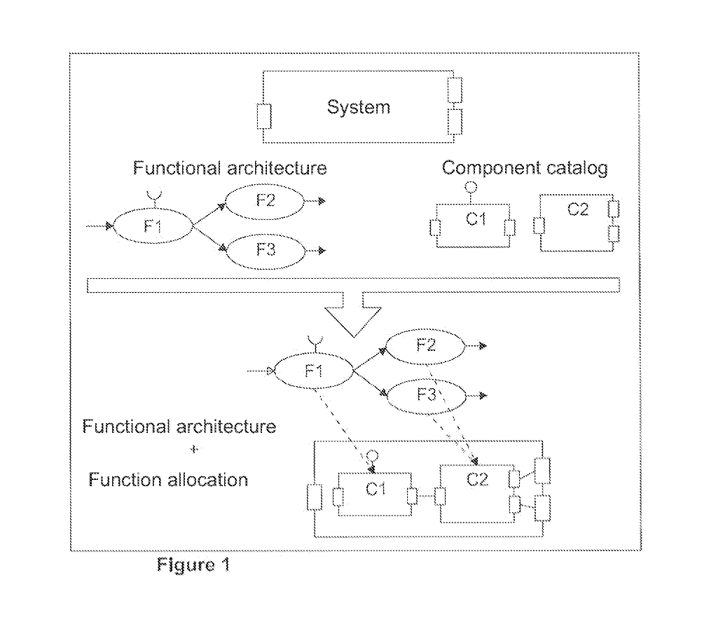

FIG. 1 illustrates the method for generating physical architectures according to the present invention.

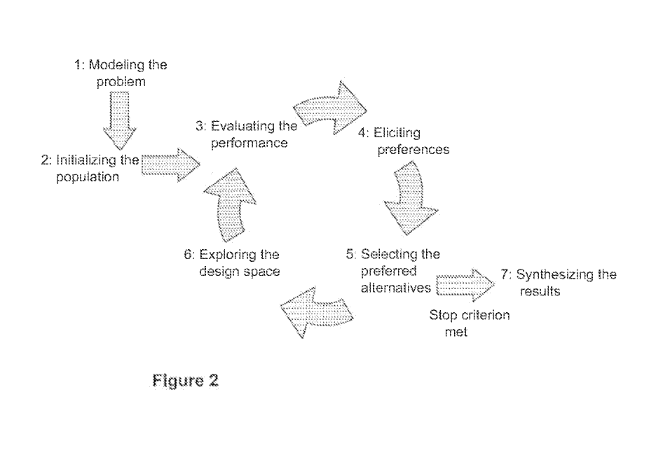

FIG. 2 illustrates the various steps of the method according to the present invention:

1. Modeling the problem

2. Initializing the population

3. Evaluating the performances

4. Eliciting preferences (optional step)

5. Selecting the preferred alternatives

6. Exploring the design space

7. Synthesizing the results

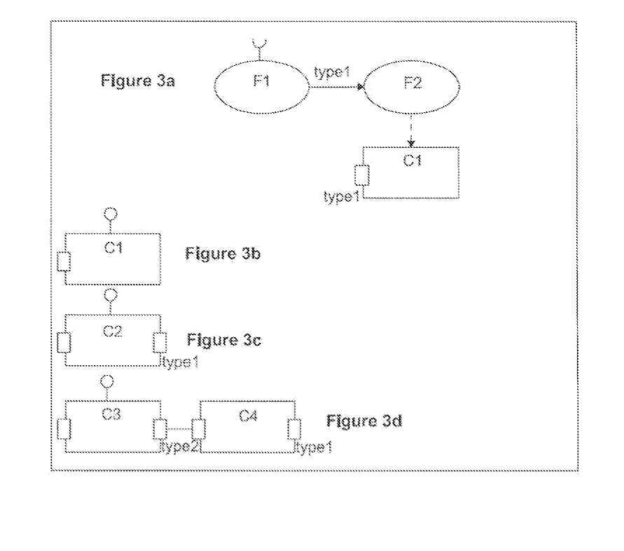

FIGS. 3a through 3d represent an exemplary search for a possible combination for a given function.

FIG. 3b represents a combination that is possible for F1 because the element illustrated is already performing F2 and has the capacity F1.

FIG. 3c represents a combination that is possible for F1 because the element illustrated is connectable to C1 and has the capacity F1.

FIG. 3d represents a combination that is possible for F1 because the element illustrated is connectible to C1 and has the capacity F1, and C2 and C4 are connectible.

The method according to the present invention begins with a modeling step during which the designer describes his problem in the form of models that can be used by the method.

The designer describes the system, its interfaces with the environment, its functional architecture, and the physical components to be considered. The modeling represents, in particular, the exchanges or possible exchanges of flows between components and between system and components. A model M is thus created.

Using this model M, physical architectures AP₁, AP₂ . . . AP_{N} are generated by an algorithm A.

The algorithm A searches for a viable and valid component chain (or combination) for each function.

The viability of the chains is defined by a port compatibility rule for the components. Thus, two components can be connected to each other only if two of their ports can be connected. The port compatibility rule comprises direction an Multiplicity rules, and can be enhanced by other rules specific to the problem (ex: connector types, male ports vs. female ports, etc.).

The validity of the chains is defined by a rule of compatibility between the chain and the function. This rule includes rules for capacity (i.e. the capacities required by the functions must be covered by the components of the chain) and for compatibility between function input/output and chain input/output (i.e. either the chain itself performs the functions that use the output flows of the function, or the chain is connectible to the chains that perform these functions).

The architectures AP₁, AP₂ . . . AP_{N} are then evaluated in terms of several attributes AT₁, AT₂ . . . AT_{P} (for example: mass, cost, availability, etc.) using analysis modules MA₁, MA₂ . . . MA_{N1}, relying on the model M to calculate the performance of the alternatives.

The best alternatives are then selected based on dominance relations.

According to another embodiment, the best alternatives are selected based on Pareto dominance relations (for example, NSGA-II—“Non-Denominated Sorting Genetic Algorithms”).

According to another embodiment, the best alternatives are selected based on dominance relations, in accordance with preferences (for example, NEMO (“Necessary-preference-enhanced Evolutionary Multiobjective Optimizer”).

The user provides information that makes it possible to give a relative importance to each of the optimization criteria/objectives.

On the basis of this selection, new alternatives AP′₁, AP′₂ . . . AP′_{N′}) are generated. To do this, modifications (genetic operators OP₁, OP₂ . . . OP_{N1}) are applied to the previous alternatives AP₁, AP₂ . . . AP_{N}.

Depending on the embodiment, the genetic operators OP₁, OP₂ . . . OP_{N1} can be of three types:
a replication operator simply replicates the alternative in the new population (identity operator);
mutation operators modify an alternative by modifying all or part of a component chain associated with a function; or
crossover operators mixing the component chains of two alternatives to create two child alternatives.

These genetic operators OP₁, OP₂ . . . OP_{N1} are applied to the architectures AP₁, AP₂ . . . AP_{N} after identifying a decoupled part of the architectures AP₁, AP₂ . . . AP_{N} (i.e. a set of components that fully performs one or more functions).

The method according to the present invention is iterative and makes it possible to progressively explore the design space, honing in on the best areas. The iterations are stopped when a stop criterion is met. This can be a number of iterations, a quality criterion for the architectures, or a convergence criterion for that quality (weak improvement of the maximum quality of the architectures). When this stop criterion is met, the final population is composed of the best architectures found.

A synthesis of the results is then performed to allow the designers to analyze the performance of the solutions, and if necessary, to reformulate the problem.

The main advantage of such an approach is that it provides increased confidence of the optimality of the physical architecture retained.

In one embodiment, the method is in the form of a computer program composed of five main subcomponents:
a main component for forming the interface between the other subcomponents and for managing the method as a whole (data flow, task sequencing, etc.);
an architect component for generating design alternatives;
a selector component for selecting, from a population of alternatives, the alternatives to be retained for the creation of new alternatives;
an evaluator component for evaluating the alternatives based on several criteria. This component must be completed by the designer based on the criteria to be evaluated and the modeling of the problem;
a synthesis component for archiving the data acquired and synthesizing them to give the designer an organized overall view of the results of the analysis.

These various components use and modify the model initially created by the user to generate the architectures, evaluate their performance, and select the best among them.

The method can be used by the designers of any highly complex system during the preliminary design phases to determine the most advantageous design alternatives.

The invention is described above by way of example. It is understood that the person skilled in the art is capable of implementing different variants of the invention without going beyond the scope of the patent.

1-10. (canceled)

11. A method for generating and optimizing physical systems architectures, comprising the steps of:
modeling a problem in a form of a model;
generating physical architectures using said model and an algorithm by an architect component to search for a function with a viable and valid combination of components;
evaluating said physical architectures according to a plurality of attributes or criteria by an evaluator component using analysis modules based on said model;
selecting a part of said physical architectures based on dominance relations by a selector component;
generating new physical architectures by applying genetic operators to said physical architectures;
synthesizing results by a synthesis component by retaining only a part of said physical architectures; and
producing physical architectures.

12. The method according to claim 11, further comprising the step of selecting the part of said physical architectures by the selector component based on Pareto dominance relations.

13. The method according to claim 12, further comprising the step of utilizing a Non-Dominated Sorting Genetic Algorithm (NSGA-II) by the selector component to select the part of said physical architectures.

14. The method according to claim 11, further comprising the step of selecting the part of said physical architectures by the selector component in accordance with preferences.

15. The method according to claim 14, further comprising the step of utilizing a Necessary-preference-enhanced Evolutionary Multi-objective Optimizer (NEMO) method by the selector component to select the part of said physical architectures

16. The method according to claim 11, wherein said genetic operators comprise a replication operator; and further comprising the step of replicating an alternative from a previous or parent population in a subsequent population by said replication operator.

17. The method according to claim 11, wherein said genetic operators comprise a mutation operator; and further comprising the step of modifying an alternative from a previous or parent population by said mutation operator by selecting and replacing a part of the architecture with an equivalent component combination to create a new or child architecture to be placed in a subsequent population, the equivalent component combination being viable and operable to perform same functions as the part of the architecture.

18. The method according to claim 11, wherein said genetic operators comprise a crossover operator; and further comprising the step of exchanging parts of two architectures from a previous or parent population with each other by said crossover operator to create two new alternatives or children population to be placed in a subsequent population.

19. The method according to claim 11, further comprising the steps of modeling the problem in the form of the model in accordance with a system, interfaces with an environment and physical components provided by a designer.

20. A non-transitory computer readable medium comprising computer program to be executed by a processor to generate and optimize physical systems architectures, the computer program comprising instructions for:
modeling a problem in a form of a model;
generating physical architectures using said model and an algorithm by an architect component to search for a function with a viable and valid combination of components;
evaluating said physical architectures according to a plurality of attributes or criteria by an evaluator component using analysis modules based on said model;
selecting a part of said physical architectures based on dominance relations by a selector component;
generating new physical architectures by applying genetic operators to said physical architectures;
synthesizing results by a synthesis component by retaining only a part of said physical architectures; and
producing physical architectures.
